(19) United States
(12) Patent Application Publication
(10) Pub. No.: US 2024/0397423 A1
(43) Pub. Date: Nov. 28, 2024

(54) TECHNIQUES FOR SCHEDULING UPLINK DISCOVERY SIGNALS IN WIRELESS COMMUNICATIONS

(71) Applicant: QUALCOMM Incorporated, San Diego, CA (US)

(72) Inventors: Jianghong LUO, Skillman, NJ (US); Navid ABEDINI, Basking Ridge, NJ (US); Naeem AKL, Bridgewater, NJ (US); Tao LUO, San Diego, CA (US)

(21) Appl. No.: 18/323,835

(22) Filed: May 25, 2023

(51) Int. Cl. H04W 52/02; H04W 72/20

(52) U.S. Cl. CPC H04W 52/0225; H04W 72/20

(57) ABSTRACT

Aspects described herein relate to transmitting, to a serving cell, a discovery signal identifier associated with an energy saving (ES) cell discovered by a user equipment (UE), receiving, from the serving cell, a resource grant scheduling resources for transmitting an uplink discovery signal to the ES cell, and transmitting, using the resources, the uplink discovery signal to the ES cell. Other aspects relate to receiving the uplink discovery signal from the UE and scheduling the UE and ES cell to respectively transmit and receive the uplink discovery signal.

### FIELD OF THE DISCLOSURE

Aspects of the present disclosure relate generally to wireless communication systems, and more particularly, to techniques for communicating discovery signals for energy savings cells.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to transmit, to a serving cell, a discovery signal identifier associated with an energy saving (ES) cell discovered by the apparatus, receive, from the serving cell, a resource grant scheduling resources for transmitting an uplink discovery signal to the ES cell, and transmit, using the resources, the uplink discovery signal to the ES cell.

In another aspect, an apparatus for wireless communication is provided that includes a transceiver, one or more memories configured to, individually or in combination, store instructions, and one or more processors communicatively coupled with the one or more memories. The one or more processors are configured to execute the instructions to cause the apparatus to transmit, in an ES state, a downlink discovery signal including a discovery signal identifier of the apparatus, receiving, from a serving cell, a resource grant scheduling resources for receiving an uplink discovery signal from a user equipment (UE), and monitoring the resources for the uplink discovery signal from the UE.

In another aspect, a method for wireless communication at a UE is provided that includes transmitting, to a serving cell, a discovery signal identifier associated with an ES cell discovered by the UE, receiving, from the serving cell, a resource grant scheduling resources for transmitting an uplink discovery signal to the ES cell, and transmitting, using the resources, the uplink discovery signal to the ES cell.

In another aspect, a method for wireless communications at an ES cell is provided that includes transmitting, in an ES state, a downlink discovery signal including a discovery signal identifier of the ES cell, receiving, from a serving cell, a resource grant scheduling resources for receiving an uplink discovery signal from a UE, and monitoring the resources for the uplink discovery signal from the UE.

In a further aspect, an apparatus for wireless communication is provided that includes a transceiver, one or more memories configured to store instructions, and one or more processors communicatively coupled with the transceiver and the one or more memories. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 illustrates an example of a wireless communications system including one or more energy saving (ES) cells, in accordance with various aspects of the present disclosure;

FIG. 4 is a block diagram illustrating an example of a user equipment (UE), in accordance with various aspects of the present disclosure;

FIG. 5 is a block diagram illustrating an example of a base station, in accordance with various aspects of the present disclosure;

FIG. 6 is a block diagram illustrating an example of an ES cell, in accordance with various aspects of the present disclosure;

FIG. 7 is a flow chart illustrating an example of a method for transmitting a UL discovery signal, in accordance with aspects described herein;

FIG. 8 is a flow chart illustrating an example of a method for receiving a UL discovery signal, in accordance with aspects described herein;

FIG. 9 is a flow chart illustrating an example of a method for scheduling resources for communicating a UL discovery signal, in accordance with aspects described herein;

FIG. 10 illustrates an example of a wireless communication system for communicating discovery signals for ES cell activation, in accordance with aspects described herein; and

FIG. 11 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to scheduling uplink discovery signal transmissions from user equipment (UE) to energy saving (ES) cells to decrease signal monitoring time and resources used by the ES cells. For example, fifth generation (5G) new radio (NR) or other wireless communication technologies can include ES cells, which may overlay wireless coverage provided by a serving cell, also referred to herein as an anchor cell for the ES cell. For example, an ES cell can be co-located or non-collocated with the anchor cell, with coverage same or partially overlapping with anchor cell. In addition, for example, the ES cell can be connected with anchor cell via wireline or wireless link, can be a potential second cell (SCell) added on top of anchor cell in a carrier aggregation (CA) framework, can be a one of multi-transmission/reception points (TRPs) of the envelope anchor cell with same of different physical cell identifier (PCI), can be a repeater, lower layer digital relay, or reconfigurable intelligent surface (RIS), etc. In any case, the ES cell can operate in an energy savings mode with decreased power or power terminated to radio frequency (RF) resources unless or until the ES cell is activated, which may be based on an uplink discovery signal, based on which the ES cell can transition from an energy savings mode to an activate mode to provide a cell for one or more UEs.

For example, an ES cell can transition between the energy saving mode and active mode. In active mode, the ES cell can transmit or receive control signals and can be prepared to provide wireless communication services. For example, the control signals can include signals for initial access, such as transmitting synchronization signal block (SSB), system information block (SIB) 1, paging signals, monitoring for physical random access channel (PRACH) signals, etc. In another example, the control signals can include signals for SCell addition/activation, such as transmitting mobility, channel, beam-measurement reference signals (RS) (e.g., SSB or channel state information (CSI)-RS). For example, a cell may only support connected UEs as SCell, and an intra-band SCell may not transmit SSB, and may rely on other intra-band serving cell for timing/beam acquisition.

In energy saving mode, the ES cell can transmit or receive over-the-air (OTA) discovery signals and/or monitor backhaul signaling for cell wakeup (e.g., for transitioning to the active state). OTA discovery signal(s) can be part of existing control signal, or some new designed signal and can indicate presence of the ES cell. For example, OTA discovery signal can be downlink (DL) only, e.g. SSB only, or primary synchronization signal (PSS) or secondary synchronization signal (SSS) only, or PSS only, or CSI-RS only, or a new designed DL preamble signal. In another example, OTA discovery signal can be uplink (UL) only, e.g. PRACH only, or sounding reference signal (SRS) only, or physical uplink control channel (PUCCH)-scheduling request (SR) only, or a new designed UL preamble signal. In yet another example, the OTA discovery signals can include both DL and UL discovery signal(s), e.g. PSS along with an UL triggering signal. For example, an ES cell can transition from an energy saving state to an active state based on receiving backhaul (BH) signaling (e.g., from the anchor cell), which may be along with receiving a UE report to network (e.g. location info). In another example, an ES cell can transition from an energy saving state to an active state based on DL discovery signal (with full cell ID) along with BH signaling, and/or along with UE report to network (e.g. Cell ID).

In another example, an ES cell can transition from an energy saving state to an active state based on an UL discovery signal, such as only using UL discovery signal (e.g., in frequency range 1 (FR1)) or in conjunction with a DL discovery signal (with no or partial cell ID). For example, the DL discovery signal can be a PSS, and can be used by a UE to acquire timing and beam for transmission of UL discovery signal. Resources for DL/UL discovery signal can be signaled by the anchor cell. Using a simplified or no DL discovery signal, in these examples, can facilitate additional energy savings at the ES cell, assuming power consumption for UL monitoring is less than that used for DL transmission. Using an UL discovery signal can resolve potential ambiguity of multiple ES cells.

Aspects described herein relate to scheduling transmission of an UL discovery signal for a UE and/or scheduling receiving of the UL discovery signal at one or more ES cells. This can provide additional power savings at an ES cell as compared to the ES cell periodically monitoring for UL discovery signals. For example, scheduling the UL discovery signal can allow the ES cell to monitor UL discovery signal at specified time or frequency resources when scheduled, as opposed to continually monitoring for UL discovery signals. In an example, the anchor cell can notify the ES cell of the scheduled UL discovery signal using backhaul/fronthaul signaling, which can conserve radio spectrum resources. For example, the fronthaul connection of the ES cell with a distributed unit (DU) of the anchor cell can consume less power than monitoring UL discovery signal, e.g. with fiber connection or narrow band mobile terminal (MT) operation on fronthaul link. Aspects described herein can provide additional power and radio spectrum resource savings for ES cells.

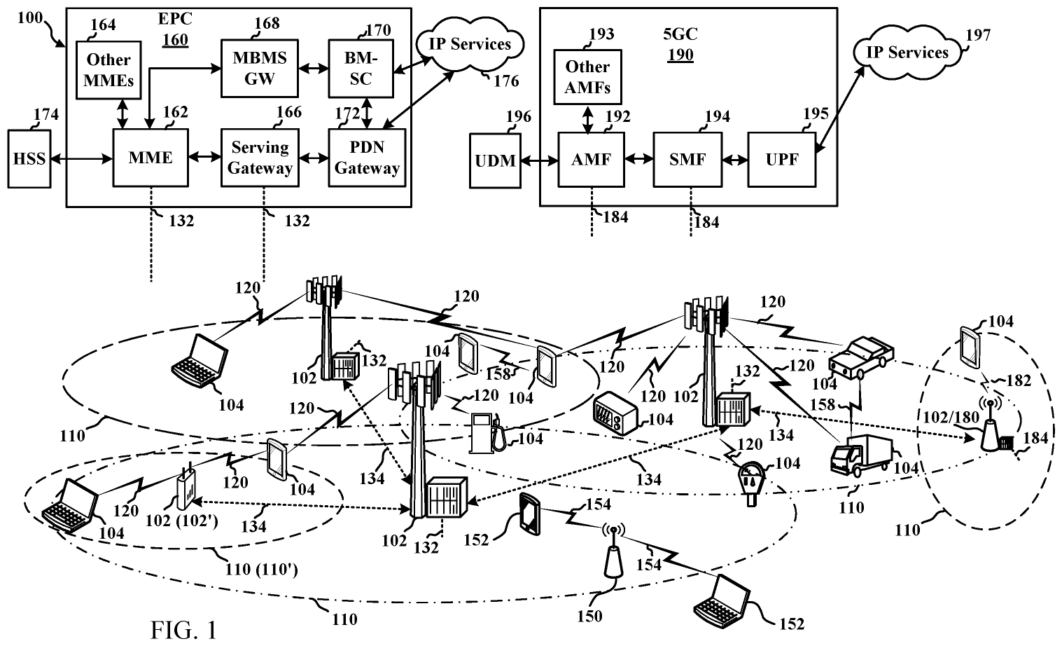

The described features will be presented in more detail below with reference to FIGS. 1-10.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X. Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X. and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHZ (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (CNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), FeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

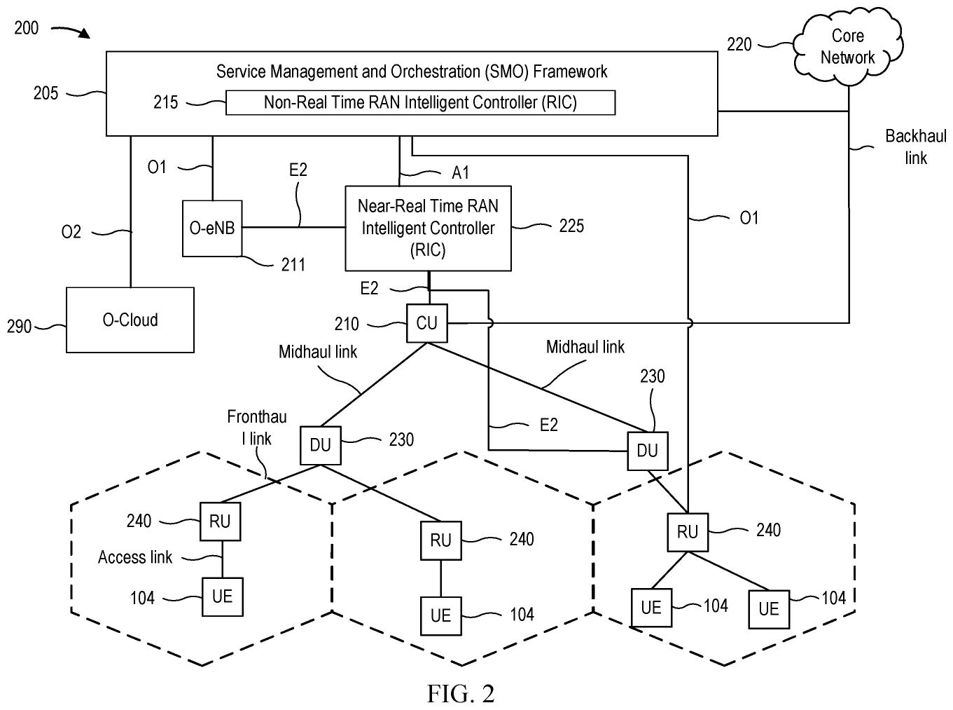

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network clement life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as Al policies).

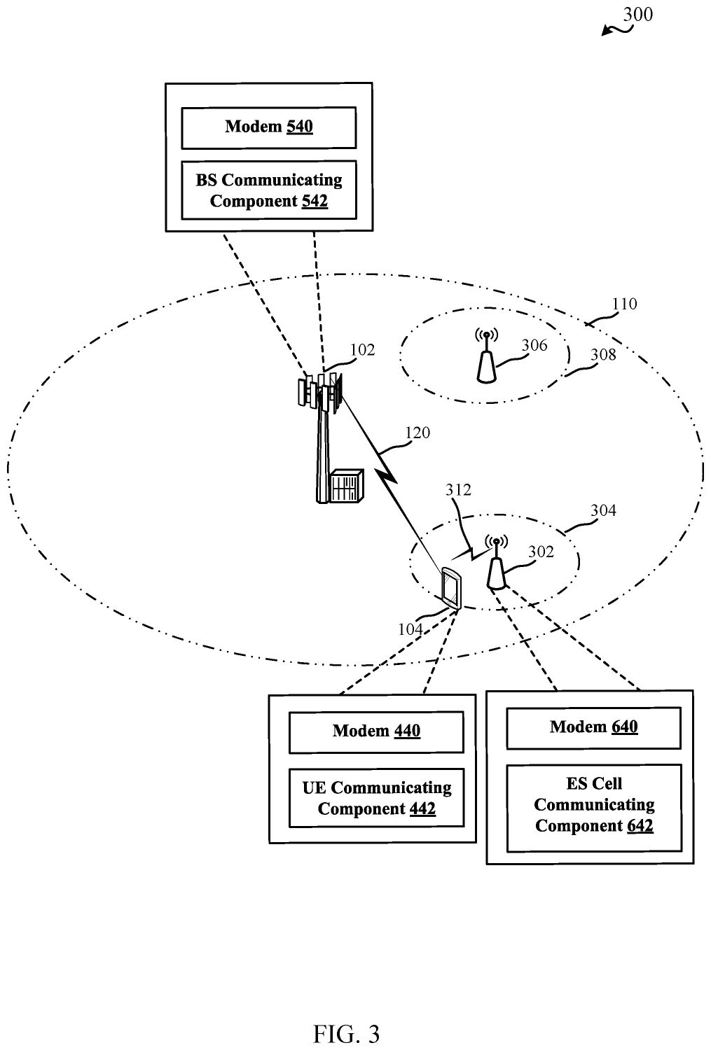

FIG. 3 illustrates an example of a wireless communications system 300 including one or more ES cells. Wireless communications system 300 includes a macro cell base station or gNB 102 that provides a geographic coverage area 110. Wireless communications system 300 also includes a ES cell 302 that provides a geographic coverage area 304, which can overlap and be smaller than geographic coverage area 110, and a ES cell 306 that provides a geographic coverage area 308. For example, the ES cells 302 and 306 can operate in an ES mode when not communicating with a UE. In wireless communications system 300, a UE 104 can communicate with the base station 102 over communications link 120, and can move into coverage of the ES cell 302. The UE 104 can detect the ES cell based on receiving a downlink discovery signal, and the ES cell can be activated for communicating with the UE 104 (in addition or alternatively to the macro cell base station 102) over communications link 312. In one example, UE 104 can communicate with the macro cell base station 102 as a PCell and the ES cell 302. once activated, as a SCell in CA. The term ES cell can refer to the network node providing the ES cell, such as a gNB, a TRP, a repeater, a relay, a RIS, etc., or can refer to the cell provided by the network node.

In an example, some nodes of the wireless communication system may have a modem 440 and UE communicating component 442 for transmitting an UL discovery signal for a ES cell, in accordance with aspects described herein. In addition, some nodes may have a modem 540 and BS communicating component 542 for scheduling transmission and/or reception of the UL discovery signal, in accordance with aspects described herein. In addition, some nodes may have a modem 640 and ES cell communicating component 642 for receiving an UL discovery signal, in accordance with aspects described herein. Though a UE 104 is shown as having the modem 440 and UE communicating component 442, a base station 102/gNB 180 is shown as having the modem 540 and BS communicating component 542, and a ES cell 302 is shown as having the modem 640 and ES cell communicating component 642, this is one illustrative example, and substantially any node or type of node may include a modem 440 and UE communicating component 442 and/or a modem 540 and BS communicating component 542 and/or a modem 640 and ES cell communicating component 642 for providing corresponding functionalities described herein.

In an example, ES cell communicating component 642 can periodically transmit a DL discovery signal. UE communicating component 442 can detect the DL discovery signal and transmit a discovery signal identifier thereof to macro cell base station 102. In an example, BS communicating component 542 can accordingly schedule the UE 104 to transmit (e.g., via physical downlink control channel (PDCCH) communication) an UL discovery signal to the ES cell 302. In addition, for example, BS communicating component 542 can schedule the ES cell 302, via backhaul signaling, to receive the UL discovery signal. UE communicating component 442 can accordingly transmit, and ES cell communicating component 642 can accordingly receive, the UL discovery signal. ES cell communicating component 642 can, based on receiving the UL discovery signal, transition from ES mode to active mode, and begin communicating with the UE 104 over communications link 312.

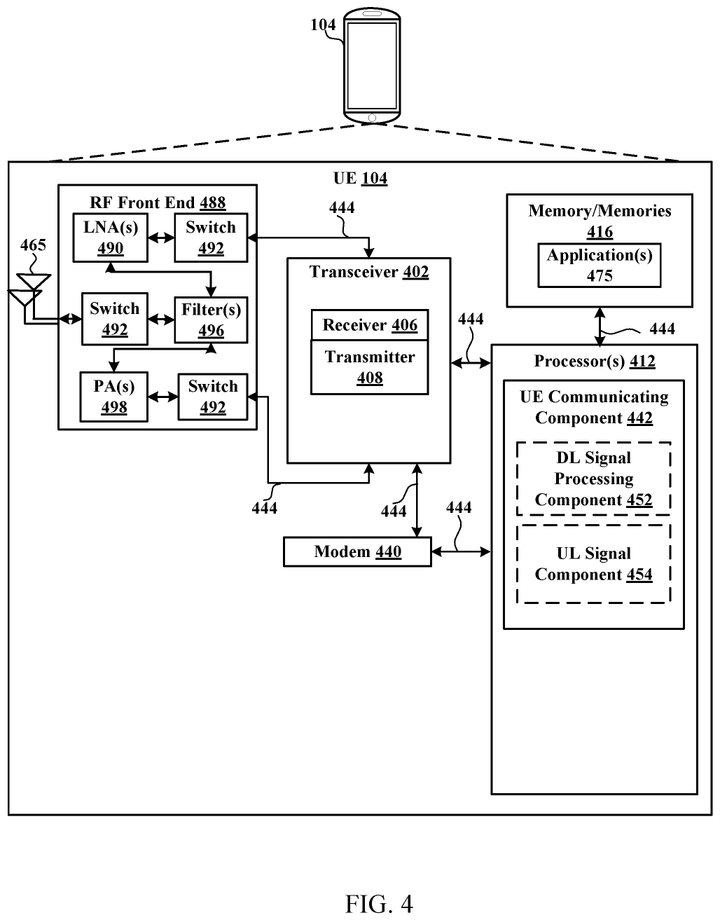

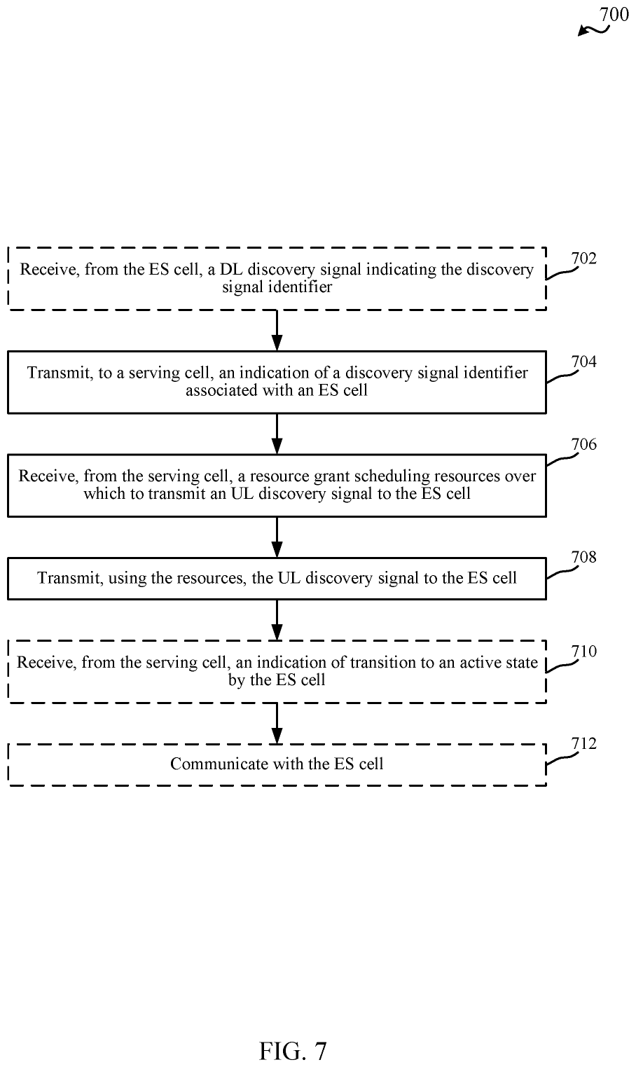

Turning now to FIGS. 4-11, aspects are depicted with reference to one or more components and one or more methods that may perform the actions or operations described herein, where aspects in dashed line may be optional. Although the operations described below in FIGS. 7-9 are presented in a particular order and/or as being performed by an example component, it should be understood that the ordering of the actions and the components performing the actions may be varied, depending on the implementation. Moreover, it should be understood that the following actions, functions, and/or described components may be performed by one or more specially programmed processors, one or more processors executing specially programmed software or computer-readable media, or by any other combination of a hardware component and/or a software component capable of performing the described actions or functions.

Referring to FIG. 4, one example of an implementation of UE 104 may include a variety of components, some of which have already been described above and are described further herein, including components such as one or more processors 412 and memory/memories 416 and transceiver 402 in communication via one or more buses 444, which may operate in conjunction with modem 440 and/or UE communicating component 442 for transmitting an UL discovery signal for a ES cell, in accordance with aspects described herein.

In an aspect, the one or more processors 412 can include a modem 440 and/or can be part of the modem 440 that uses one or more modem processors. Thus, the various functions related to UE communicating component 442 may be included in modem 440 and/or processors 412 and, in an aspect, can be executed by a single processor, while in other aspects, different ones of the functions may be executed by a combination of two or more different processors. For example, in an aspect, the one or more processors 412 may include any one or any combination of a modem processor, or a baseband processor, or a digital signal processor, or a transmit processor, or a receiver processor, or a transceiver processor associated with transceiver 402. In other aspects, some of the features of the one or more processors 412 and/or modem 440 associated with UE communicating component 442 may be performed by transceiver 402.

Also, memory/memories 416 may be configured to store data used herein and/or local versions of applications 475 or UE communicating component 442 and/or one or more of its subcomponents being executed by at least one processor 412. Memory/memories 416 can include any type of computer-readable medium usable by a computer or at least one processor 412, such as random access memory (RAM), read only memory (ROM), tapes, magnetic discs, optical discs, volatile memory, non-volatile memory, and any combination thereof. In an aspect, for example, memory/memories 416 may be a non-transitory computer-readable storage medium that stores one or more computer-executable codes defining UE communicating component 442 and/or one or more of its subcomponents, and/or data associated therewith, when UE 104 is operating at least one processor 412 to execute UE communicating component 442 and/or one or more of its subcomponents.

Transceiver 402 may include at least one receiver 406 and at least one transmitter 408. Receiver 406 may include hardware, firmware, and/or software code executable by a processor for receiving data, the code comprising instructions and being stored in a memory/memories (e.g., computer-readable medium). Receiver 406 may be, for example, a radio frequency (RF) receiver. In an aspect, receiver 406 may receive signals transmitted by at least one base station 102 or ES cell 302 or 306. Additionally, receiver 406 may process such received signals, and also may obtain measurements of the signals, such as, but not limited to, Ec/Io, signal-to-noise ratio (SNR), reference signal received power (RSRP), received signal strength indicator (RSSI), etc. Transmitter 408 may include hardware, firmware, and/or software code executable by a processor for transmitting data, the code comprising instructions and being stored in a memory/memories (e.g., computer-readable medium). A suitable example of transmitter 408 may including, but is not limited to, an RF transmitter.

Moreover, in an aspect, UE 104 may include RF front end 488, which may operate in communication with one or more antennas 465 and transceiver 402 for receiving and transmitting radio transmissions, for example, wireless communications transmitted by at least one base station 102 or ES cell 302 or 306 or wireless transmissions transmitted by UE 104. RF front end 488 may be connected to one or more antennas 465 and can include one or more low-noise amplifiers (LNAs) 490, one or more switches 492, one or more power amplifiers (PAS) 498, and one or more filters 496 for transmitting and receiving RF signals.

In an aspect, LNA 490 can amplify a received signal at a desired output level. In an aspect, each LNA 490 may have a specified minimum and maximum gain values. In an aspect, RF front end 488 may use one or more switches 492 to select a particular LNA 490 and its specified gain value based on a desired gain value for a particular application.

Further, for example, one or more PA(s) 498 may be used by RF front end 488 to amplify a signal for an RF output at a desired output power level. In an aspect, each PA 498 may have specified minimum and maximum gain values. In an aspect, RF front end 488 may use one or more switches 492 to select a particular PA 498 and its specified gain value based on a desired gain value for a particular application.

Also, for example, one or more filters 496 can be used by RF front end 488 to filter a received signal to obtain an input RF signal. Similarly, in an aspect, for example, a respective filter 496 can be used to filter an output from a respective PA 498 to produce an output signal for transmission. In an aspect, each filter 496 can be connected to a specific LNA 490 and/or PA 498. In an aspect, RF front end 488 can use one or more switches 492 to select a transmit or receive path using a specified filter 496, LNA 490, and/or PA 498, based on a configuration as specified by transceiver 402 and/or processor 412.

As such, transceiver 402 may be configured to transmit and receive wireless signals through one or more antennas 465 via RF front end 488. In an aspect, transceiver may be tuned to operate at specified frequencies such that UE 104 can communicate with, for example, one or more base stations 102 or ES cell 302 or 306 or one or more cells associated with one or more base stations 102 or ES cell 302 or 306. In an aspect, for example, modem 440 can configure transceiver 402 to operate at a specified frequency and power level based on the UE configuration of the UE 104 and the communication protocol used by modem 440.

In an aspect, modem 440 can be a multiband-multimode modem, which can process digital data and communicate with transceiver 402 such that the digital data is sent and received using transceiver 402. In an aspect, modem 440 can be multiband and be configured to support multiple frequency bands for a specific communications protocol. In an aspect, modem 440 can be multimode and be configured to support multiple operating networks and communications protocols. In an aspect, modem 440 can control one or more components of UE 104 (e.g., RF front end 488, transceiver 402) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 442 can optionally include a DL signal processing component 452 for processing a received DL discovery signal related to a ES cell, and/or an UL signal component 454 for generating and/or transmitting an UL discovery signal for the ES cell.

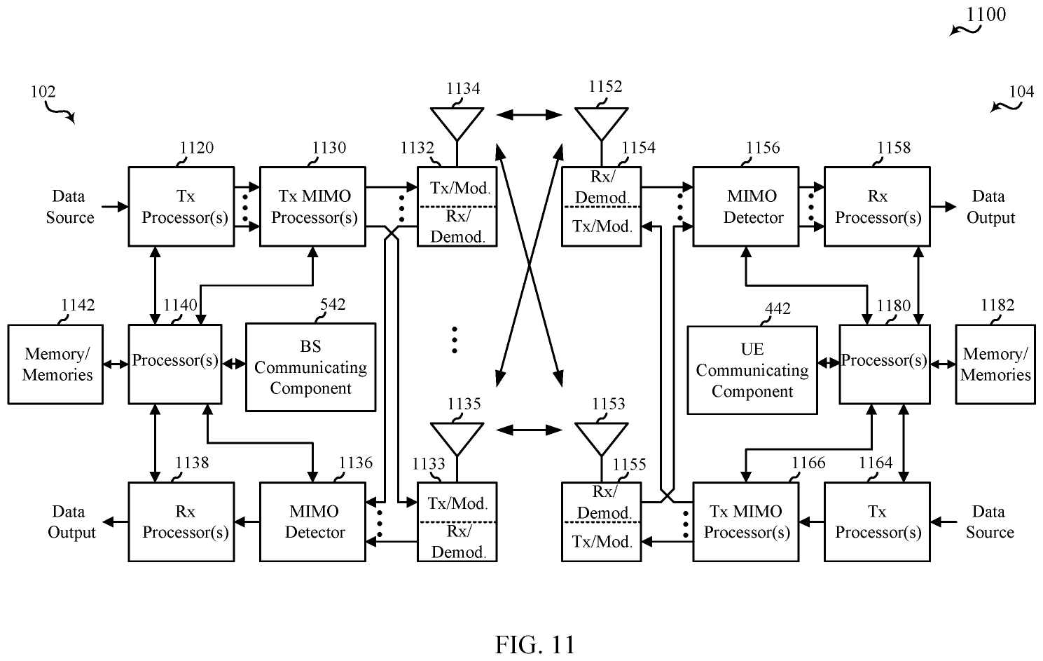

In an aspect, the processor(s) 412 may correspond to one or more of the processors described in connection with the UE in FIG. 11. Similarly, the memory/memories 416 may correspond to the memory/memories described in connection with the UE in FIG. 11.

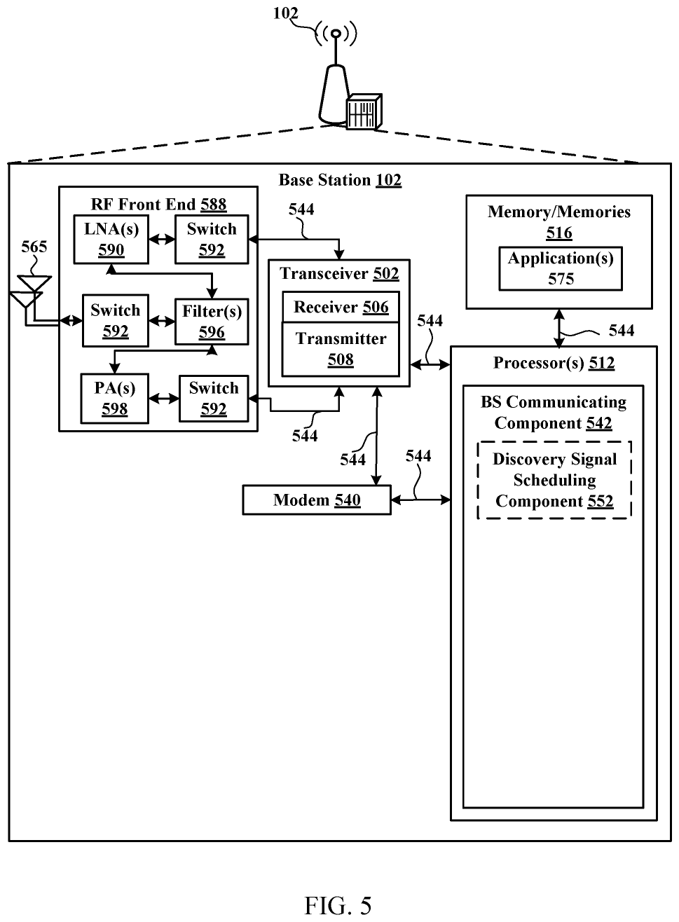

Referring to FIG. 5, one example of an implementation of base station 102 (e.g., a base station 102 and/or gNB 180, as described above) may include a variety of components, some of which have already been described above, but including components such as one or more processors 512 and memory/memories 516 and transceiver 502 in communication via one or more buses 544, which may operate in conjunction with modem 540 and BS communicating component 542 for scheduling transmission and/or reception of the UL discovery signal, in accordance with aspects described herein.

The transceiver 502, receiver 506, transmitter 508, one or more processors 512, memory/memories 516, applications 575, buses 544, RF front end 588, LNAs 590, switches 592, filters 596, PAs 598, and one or more antennas 565 may be the same as or similar to the corresponding components of UE 104, as described above, but configured or otherwise programmed for base station operations as opposed to UE operations.

In an aspect, BS communicating component 542 can optionally include a discovery signal scheduling component 552 for scheduling resources for a UE to transmit, and/or for a ES cell to receive, an UL discovery signal.

In an aspect, the processor(s) 512 may correspond to one or more of the processors described in connection with the base station in FIG. 11. Similarly, the memory/memories 516 may correspond to the memory/memories described in connection with the base station in FIG. 11.

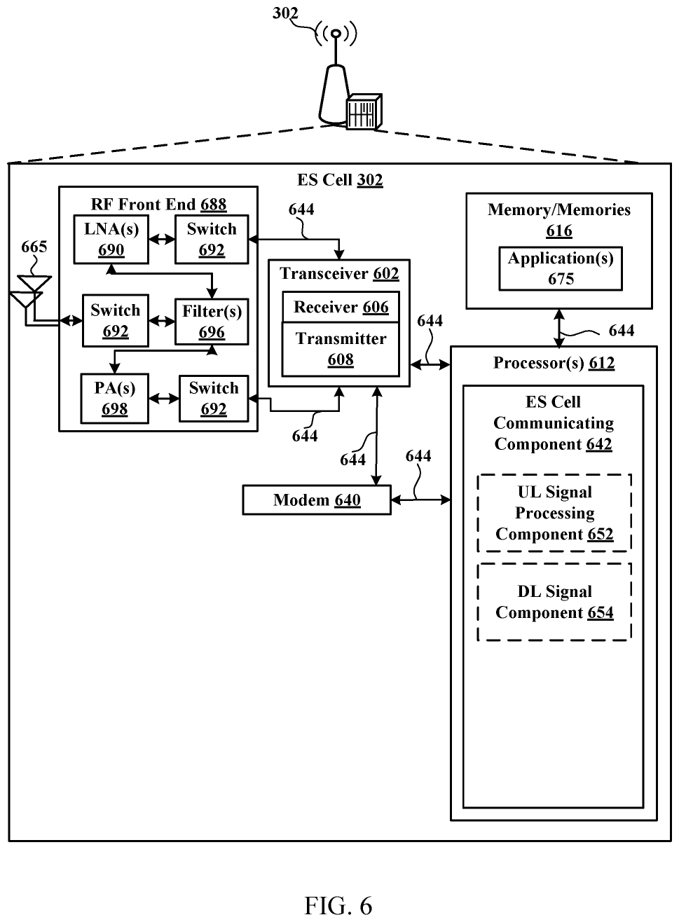

Referring to FIG. 6, one example of an implementation of base station 102 (e.g., a base station 102 and/or gNB 180, as described above) may include a variety of components, some of which have already been described above, but including components such as one or more processors 612 and memory/memories 616 and transceiver 602 in communication via one or more buses 644, which may operate in conjunction with modem 640 and ES cell communicating component 642 for receiving an UL discovery signal, in accordance with aspects described herein.

The transceiver 602, receiver 606, transmitter 608, one or more processors 612, memory/memories 616, applications 675, buses 644, RF front end 688, LNAs 690, switches 692, filters 696, PAs 698, and one or more antennas 665 may be the same as or similar to the corresponding components of UE 104, as described above, but configured or otherwise programmed for base station operations as opposed to UE operations.

In an aspect, ES cell communicating component 642 can optionally include a UL signal processing component 652 for processing an UL discovery signal received from a UE, and/or a DL signal component 654 for transmitting a DL discovery signal to facilitate discovering the ES cell.

In an aspect, the processor(s) 612 may correspond to one or more of the processors described in connection with the base station in FIG. 11. Similarly, the memory/memories 616 may correspond to the memory/memories described in connection with the base station in FIG. 11.

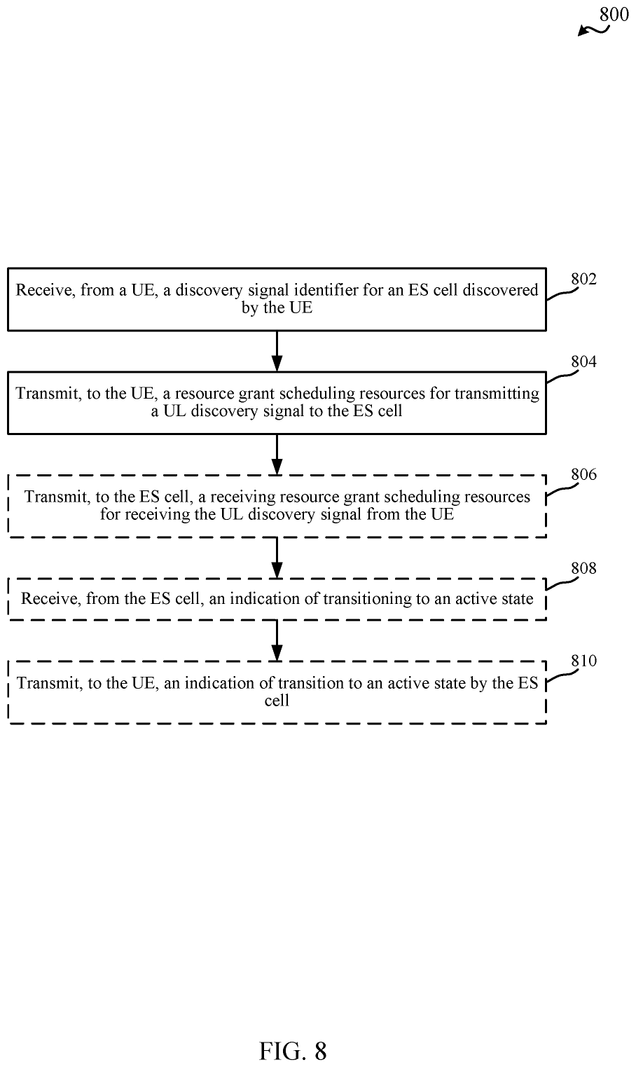

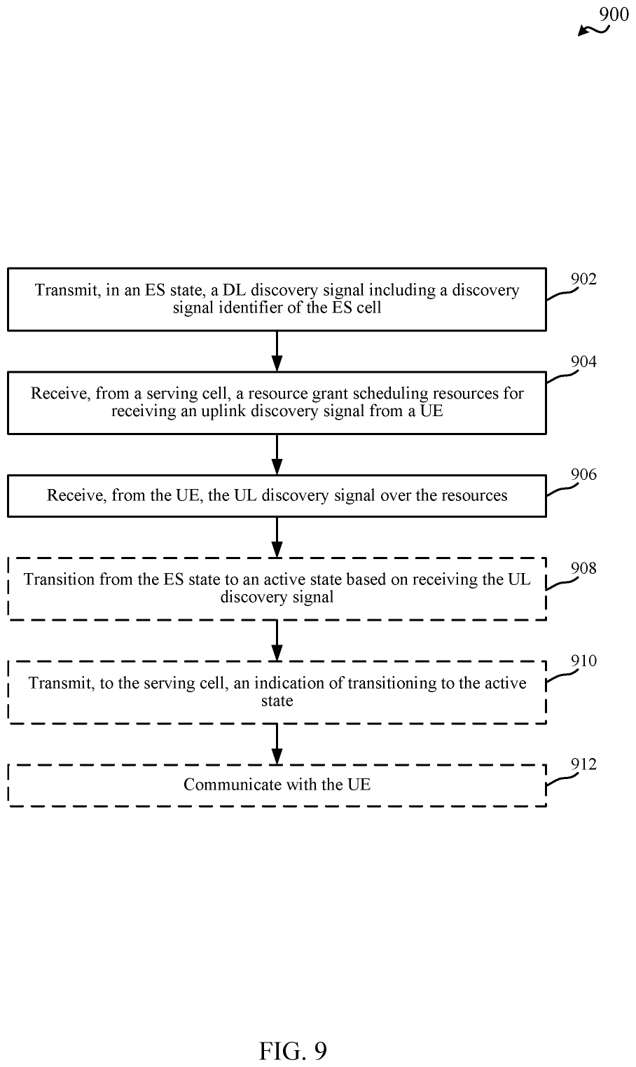

FIG. 7 illustrates a flow chart of an example of a method 700 for transmitting a UL discovery signal, in accordance with aspects described herein. FIG. 8 illustrates a flow chart of an example of a method 800 for receiving a UL discovery signal, in accordance with aspects described herein. FIG. 9 illustrates a flow chart of an example of a method 900 for scheduling resources for communicating a UL discovery signal, in accordance with aspects described herein. In an example, a UE 104 or other device (e.g., an IoT device, EH device, etc.) can perform the functions described in method 700 shown in FIG. 7 using one or more of the components described in FIGS. 3 and 4. In an example, a network node (e.g., a base station 102 or gNB 180, a monolithic base station or gNB, a portion of a disaggregated base station or gNB, etc.), a UE 104 in sidelink communications, etc. can perform the functions described in method 800 shown in FIG. 8 using one or more of the components described in FIGS. 3 and 5. In an example, a network node, such as a ES cell 302 or 306, a UE 104 in sidelink communications, etc. can perform the functions described in method 900 shown in FIG. 9 using one or more of the components described in FIGS. 3 and 6. Methods 700, 800, and 900 are described in conjunction with one another for case of explanation; however, the methods 700, 800, and 900 are not required to be performed together and indeed separate devices can be configured to perform and/or can perform one of the methods 700, 800, or 900 without requiring another device.

In method 900, at Block 902, a DL discovery signal including a discovery signal identifier of the ES cell can be transmitted in an ES state. In an aspect, DL signal component 654, e.g., in conjunction with processor(s) 612, memory/memories 616, transceiver 602, ES cell communicating component 642, etc., can transmit, in the ES state, the DL discovery signal including the discovery signal identifier of the ES cell. For example, ES cell 302 can operate in an ES state, as described, where power can be terminated or reduced from RF components, such as RF front end 688, except for time instances configured for transmitting a periodic DL discovery signal and/or receiving a corresponding UL discovery signal from one or more UEs 104 that were able to receive and process the DL discovery signal. During these time instances, power can be provided to the RF components to transmit and/or receive discovery signals. In accordance with aspects described herein, the ES cell 302 can power or activate the RF components to receive the UL discovery signal when scheduled by the macro cell base station 102, such to provide additional power savings at the ES cell 302. In an example, the DL discovery signal can include a discovery signal identifier that identifies the ES cell 302. In one example, the DL discovery signal can include a PSS or other signal that may or may not have a cell identifier or a partial cell identifier.

In method 700, optionally at Block 702, a DL discovery signal indicating the discovery signal identifier of the ES cell can be received from the ES cell. In an aspect, DL signal processing component 452, e.g., in conjunction with processor(s) 412. memory/memories 416, transceiver 402, UE communicating component 442, etc., can receive, from the ES cell, the DL discovery signal indicating the discovery signal identifier. For example, when the UE 104 is within range of the ES cell 302, it can receive the periodically transmitted DL discovery signal therefrom. The UE 104 can accordingly determine that it is within range of the ES cell 302, and can request access to the ES cell 302 to provide additional coverage or services for the UE 104. In one example, the DL discovery signal can include a PSS or other signal that may or may not have a cell identifier or a partial cell identifier. For example, UL signal component 454 can use the PSS or other signal to acquire timing and beam for transmission of the UL discovery signal, as described herein.

In method 700, at Block 704, an indication of a discovery signal identifier associated with an ES cell can be transmitted to a serving cell. In an aspect, UL signal component 454, e.g., in conjunction with processor(s) 412, memory/memories 416. transceiver 402, UE communicating component 442, etc., can transmit, to the serving cell, the indication of the discovery signal identifier associated with the ES cell (e.g., ES cell 302). For example, the UE 104 can be served by and/or communicating with the serving cell (e.g., a cell provided by the macro cell base station 102), and can transmit the discovery signal identifier of the ES cell, which can be received in the DL discovery signal from the ES cell. For example, UL signal component 454 can transmit the discovery signal identifier to the serving cell over a control channel, such as PUCCH, a shared channel, such as physical uplink shared channel (PUSCH), etc.

In method 800, at Block 802, a discovery signal identifier for an ES cell discovered by the UE can be received from the UE. In an aspect, discovery signal scheduling component 552, e.g., in conjunction with processor(s) 512, memory/memories 516, transceiver 502, BS communicating component 542, etc., can receive, from the UE, the discovery signal identifier for the ES cell discovered by the UE. As described, for example, discovery signal scheduling component 552 can receive the discovery signal identifier from the UE 104 in a control channel, such as PUCCH, a shared channel, such as PUSCH, etc. The base station 102 can accordingly schedule the UE 104 to transmit a UL discovery signal to the ES cell to cause the ES cell to transition to an active state.

In method 800, at Block 804, a resource grant scheduling resources for transmitting an UL discovery signal to the ES cell can be transmitted to the UE. In an aspect, discovery signal scheduling component 552, e.g., in conjunction with processor(s) 512, memory/memories 516, transceiver 502, BS communicating component 542, etc., can transmit, to the UE, the resource grant scheduling resources for transmitting the UL discovery signal to the ES cell. For example, discovery signal scheduling component 552 can select time and/or frequency resources for the UE 104 to use in transmitting a UL discovery signal to the ES cell corresponding to the discovery signal identifier received from the UE 104, and can transmit the resource grant to the UE 104 that schedules the resources. For example, discovery signal scheduling component 552 can transmit the resource grant to the UE 104 using downlink control information (DCI) over PDCCH or PDSCH.

In method 800, optionally at Block 806, a receiving resource grant scheduling resources for receiving the UL discovery signal from the UE can be transmitted to the ES cell. In an aspect, discovery signal scheduling component 552, e.g., in conjunction with processor(s) 512, memory/memories 516, transceiver 502, BS communicating component 542, etc., can transmit, to the ES cell, the receiving resource grant scheduling resources for receiving the UL discovery signal from the UE. For example, discovery signal scheduling component 552 can transmit, to the ES cell over a backhaul connection, the receiving resource grant, or another indication of the resources over which base station 102 scheduled the UE 104 to transmit the UL discovery signal.

In method 900, at Block 904, a resource grant scheduling resources for receiving an UL discovery signal from a UE can be received from a serving cell. In an aspect, UL signal processing component 652, e.g., in conjunction with processor(s) 612, memory/memories 616, transceiver 602, ES cell communicating component 642, etc., can receive, from the serving cell, the resource grant scheduling resource for receiving the UL discovery signal from the UE. For example, UL signal processing component 652 can receive the resource grant, or other indication of the resources over which base station 102 scheduled the UE 104 to transmit the UL discovery signal, from the serving cell (e.g., from the macro cell base station 102 providing the macro cell that the ES cell overlaps).

In method 700, at Block 706, a resource grant scheduling resources over which to transmit an UL discovery signal to the ES cell can be received from the serving cell. In an aspect, UL signal component 454, e.g., in conjunction with processor(s) 412, memory/memories 416, transceiver 402, UE communicating component 442, etc., can receive, from the serving cell, the resource grant scheduling resources over which to transmit the UL discovery signal to the ES cell. For example, UL signal component 454 can receive the resource grant from the base station 102 in DCI received over PDCCH, PDSCH, etc., as described.

In method 700, at Block 708, the UL discovery signal can be transmitted to the ES cell using the resources. In an aspect, UL signal component 454, e.g., in conjunction with processor(s) 412, memory/memories 416, transceiver 402, UE communicating component 442, etc., can transmit, using the resources in the resource grant, the UL discovery signal to the ES cell. For example, the UL discovery signal can be a signal that causes the ES cell to transition to an active state. The UL discovery signal may include the discovery signal identifier to identify the intended ES cell.

In method 900, at Block 906, the UL discovery signal can be received from the UE over the resources. In an aspect, UL signal processing component 652, e.g., in conjunction with processor(s) 612, memory/memories 616, transceiver 602, ES cell communicating component 642, etc., can receive, from the UE, the UL discovery signal over the resources. For example, UL signal processing component 652 can activate RF components during the resources to potentially receive the UL discovery signal from the UE. This can allow the ES cell to remain in the ES state unless or until a UE 104 discovers the ES cell and notifies the serving cell.

In method 900, optionally at Block 908, an active state can be transitioned to from an ES state based on receiving the UL discovery signal. In an aspect, UL signal processing component 652, e.g., in conjunction with processor(s) 612, memory/memories 616, transceiver 602, ES cell communicating component 642, etc., can transition from the ES state (where ES cell is operating in the ES state) to an active state based on receiving the UL discovery signal. For example, UL signal processing component 652 can activate (or maintain power to) RF components in transitioning to the active state based on receiving the UL discovery signal. In an example, UL signal processing component 652 can verify a discovery signal identifier in the UL discovery signal matches an identifier of the ES cell.

In method 900, optionally at Block 910, an indication of transitioning to the active state can be transmitted to the serving cell. In an aspect. ES cell communicating component 642, e.g., in conjunction with processor(s) 612, memory/memories 616, transceiver 602, etc., can transmit, to the serving cell, the indication of transitioning to the active state. For example, ES cell communicating component 642 can transmit the indication over a fronthaul link to the base station 102.

In method 800, optionally at Block 808, an indication of transitioning to an active state can be received from the ES cell. In an aspect, BS communicating component 542, e.g., in conjunction with processor(s) 512, memory/memories 516, transceiver 502, etc., can receive, from the ES cell, the indication of transitioning to the active state. For example, BS communicating component 542 can receive this indication over a fronthaul link with the ES cell. The ES cell can transition to the active state based on receiving the scheduled UL discovery signal, as described.

In method 800, optionally at Block 810, an indication of transition to an active state by the ES cell can be transmitted to the UE. In an aspect, BS communicating component 542, e.g., in conjunction with processor(s) 512, memory/memories 516, transceiver 502, etc., can transmit, to the UE, the indication of transition to the active state by the ES cell. This can be in response to receiving the indication at Block 808. For example, BS communicating component 542 can transmit the indication to the UE 104 over PDCCH, PDSCH, etc.

In method 700, optionally at Block 710, an indication of transition to an active state by the ES cell can be received from a serving cell. In an aspect, UE communicating component 442, e.g., in conjunction with processor(s) 412, memory/memories 416, transceiver 402, etc., can receive, from the serving cell, the indication of transition to the active state by the ES cell. For example, UE communicating component 442 can receive the indication from the base station 102 over PDCCH, PDSCH, etc. The indication may be in response to the ES cell receiving the UL discovery signal from the UE 104, as described.

In method 700, optionally at Block 712, the ES cell can be communicated with. In an aspect, UE communicating component 442, e.g., in conjunction with processor(s) 412, memory/memories 416, transceiver 402, etc., can communicate with the ES cell. For example, UE communicating component can transmit a RACH message to the ES cell or otherwise perform a RACH procedure to establish a connection with the ES cell (e.g., in addition to the serving cell) based on transition of the ES cell to the active state. In one example, the serving cell can configure the ES cell as a SCell (e.g., in CA), as described above.

In method 900, optionally at Block 912, the UE can be communicated with. In an aspect, ES cell communicating component 642, e.g., in conjunction with processor(s) 612, memory/memories 616, transceiver 602, etc., can communicate with the UE. For example, ES cell communicating component 642 can receive, from the UE, a RACH message or otherwise perform a RACH procedure with the UE to establish a connection therewith.

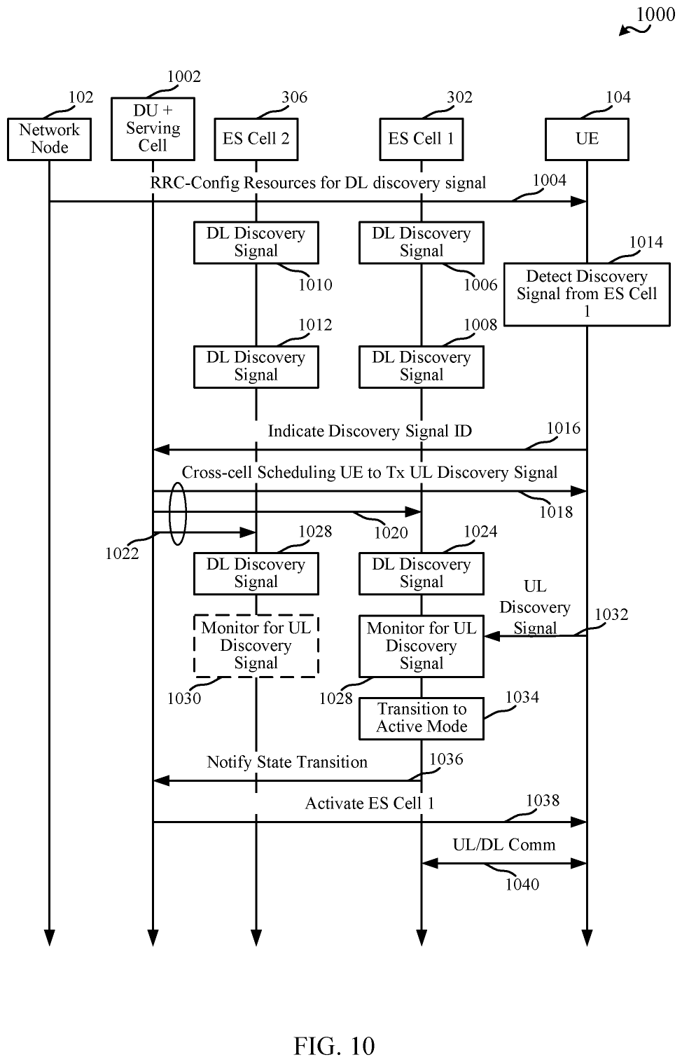

FIG. 10 illustrates an example of a wireless communication system 1000 for communicating discovery signals for ES cell activation. Wireless communication system 1000 includes a network node 102, which can be a base station or other node that provides a serving cell (also referred to as an anchor cell), such as a macro cell, etc., as described, which one or more ES cells can overlap in coverage. Network node 102 can include a distributed unit function providing the serving cell 1002, which may be on a different node coupled to the network node 102 or co-located with the network node 102. Wireless communication system 1000 also includes a ES cell 1 302 and ES cell 2 306 providing coverage within the coverage area of the serving cell 102, as described herein, and which can be configured as an SCell or otherwise configured for the UE 104 to utilize when in coverage of the ES cell (and where the ES cell transitions from an ES mode to an active mode).

In an example, the network node 102 can transmit, to the UE 104, an indication of resources for DL discovery signal at 1004. For example, this can include a RRC configuration indicating the resources for receiving DL discovery signals from one or more ES cells. ES cell 1 302 can transmit periodic DL discovery signals 1006, 1008 over the indicated resources, and ES cell 2 306 can transmit periodic DL discovery signals 1010, 1012 over the indicated resources. UE 104 can attempt to receive one or more of the DL discovery signals 1006, 1008, 1010, and/or 1012 over the resources based on the configuration received at 1004. For example, UE 104 can receive DL discovery signal 1006 from ES cell 1. In this example, UE 104 can detect the discovery signal from ES cell 1 at 1014. Based on detecting the discovery signal, and/or other determination to communicate with the ES cell 1 302, UE 104 can indicate, to the serving cell 1002, a discovery signal ID received in the DL discovery signal 1006 at 1016.

Based on receiving the discovery signal ID, the serving cell 1002 can perform cross-cell scheduling of resources for the UE to transmit an UL discovery signal, which can include scheduling the UE at 1018, scheduling ES cell 1 302 at 1020, and/or scheduling ES cell 2 306 at 1022. In one example, serving cell 1002 may schedule ES cell 1 302 at 1020 based on determining that ES cell 1 302 corresponds to the received discovery signal identifier. ES cell 1 302 can transmit the periodic DL discovery signal at 1024, and ES cell 2 306 can transmit the periodic DL discovery signal at 1026. In an example, at least the ES cell 1 302 can then monitor for UL discovery signal at 1028 based on receiving the cross-cell scheduling of the resources at 1020. In an example, the ES cell 2 306 may also monitor for UL discovery signal at 1030. This can depend on whether ES cell 2 306 receives the resources for cross-cell scheduling or not at 1022. In another example, the cross-cell scheduling transmitted to the ES cells (e.g., over backhaul connection) at 1020 and 1022 may include a discovery cell identifier, and whether the ES cell monitors for UL discovery signal can be based on whether the cross-cell scheduling includes a discovery cell identifier for the corresponding ES cell.

UE 104 can transmit the UL discovery signal at 1032 over the scheduled resources at 1032, and ES cell 1 302 can receive the UL discovery signal when monitoring for the UL discovery signal at 1028. Based on receiving the UL discovery signal at 1032, ES cell 1 302 can transition to an active mode 1034 to provide another cell for UE 104. ES cell 1 302 can notify the serving cell 1002 of the state transition from ES mode to active mode at 1036, and serving cell 1002 can accordingly activate the ES cell 1 for the UE 104 at 1038 (e.g., activate ES cell 1 302 as a SCell). Based on activation of the ES cell 1 302, UE 104 and ES cell 1 302 can perform uplink/downlink communications with one another at 1040, which can include first performing a RACH procedure to establish a connection between the UE 104 and ES cell 1 302.

FIG. 11 is a block diagram of a MIMO communication system 1100 including a base station 102 and a UE 104. The MIMO communication system 1100 may illustrate aspects of the wireless communication access network 100 described with reference to FIG. 1. The base station 102 may be an example of aspects of the base station 102 or ES cell 302 described with reference to FIGS. 1 and 3. The base station 102 may be equipped with antennas 1134 and 1135, and the UE 104 may be equipped with antennas 1152 and 1153. In the MIMO communication system 1100, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor(s) 1120 may receive data from a data source. The transmit processor(s) 1120 may process the data. The transmit processor(s) 1120 may also generate control symbols or reference symbols. A transmit MIMO processor(s) 1130 may perform spatial processing (e.g., precoding) on data symbols, control symbols, or reference symbols, if applicable, and may provide output symbol streams to the transmit modulator/demodulators 1132 and 1133. Each modulator/demodulator 1132 through 1133 may process a respective output symbol stream (e.g., for OFDM, etc.) to obtain an output sample stream. Each modulator/demodulator 1132 through 1133 may further process (e.g., convert to analog, amplify, filter, and upconvert) the output sample stream to obtain a DL signal. In one example, DL signals from modulator/demodulators 1132 and 1133 may be transmitted via the antennas 1134 and 1135, respectively.

The UE 104 may be an example of aspects of the UEs 104 described with reference to FIGS. 1. 3, and 4. At the UE 114, the UE antennas 1152 and 1153 may receive the DL signals from the base station 102 and may provide the received signals to the modulator/demodulators 1154 and 1155, respectively. Each modulator/demodulator 1154 through 1155 may condition (e.g., filter, amplify, downconvert, and digitize) a respective received signal to obtain input samples. Each modulator/demodulator 1154 through 1155 may further process the input samples (e.g., for OFDM, etc.) to obtain received symbols. A MIMO detector 1156 may obtain received symbols from the modulator/demodulators 1154 and 1155, perform MIMO detection on the received symbols, if applicable, and provide detected symbols. A receive (Rx) processor(s) 1158 may process (e.g., demodulate, deinterleave, and decode) the detected symbols, providing decoded data for the UE 104 to a data output, and provide decoded control information to a processor(s) 1180, or memory/memories 1182.

The processor(s) 1180 may in some cases execute stored instructions to instantiate a UE communicating component 442 (see e.g., FIGS. 3 and 4).

On the uplink (UL), at the UE 104, a transmit processor(s) 1164 may receive and process data from a data source. The transmit processor(s) 1164 may also generate reference symbols for a reference signal. The symbols from the transmit processor(s) 1164 may be precoded by a transmit MIMO processor(s) 1166 if applicable, further processed by the modulator/demodulators 1154 and 1155 (e.g., for single carrier-FDMA, etc.), and be transmitted to the base station 102 in accordance with the communication parameters received from the base station 102. At the base station 102, the UL signals from the UE 104 may be received by the antennas 1134 and 1135, processed by the modulator/demodulators 1132 and 1133, detected by a MIMO detector 1136 if applicable, and further processed by a receive processor(s) 1138. The receive processor(s) 1138 may provide decoded data to a data output and to the processor(s) 1140 or memory/memories 1142.

The processor(s) 1140 may in some cases execute stored instructions to instantiate a BS communicating component 542 (see e.g., FIGS. 3 and 5), or ES cell communicating component 642 (not shown, see e.g., FIGS. 3 and 6).

The components of the UE 104 may, individually or collectively, be implemented with one or more ASICs adapted to perform some or all of the applicable functions in hardware. Each of the noted modules may be a means for performing one or more functions related to operation of the MIMO communication system 1100. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1100.

The following aspects are illustrative only and aspects thereof may be combined with aspects of other embodiments or teaching described herein, without limitation.

Aspect 1 is a method for wireless communication at a UE including transmitting, to a serving cell, a discovery signal identifier associated with an ES cell discovered by the UE, receiving, from the serving cell, a resource grant scheduling resources for transmitting an uplink discovery signal to the ES cell, and transmitting, using the resources, the uplink discovery signal to the ES cell.

In Aspect 2, the method of Aspect 1 includes receiving, from the ES cell, a downlink discovery signal indicating the discovery signal identifier, wherein transmitting the discovery signal identifier to the serving cell is based on receiving the downlink discovery signal.

In Aspect 3, the method of Aspect 2 includes wherein the downlink discovery signal includes a reference signal indicating the presence of the ES cell.

In Aspect 4, the method of any of Aspects 2 or 3 includes wherein the downlink discovery signal is a PSS.

In Aspect 5, the method of any of Aspects 1 to 4 includes receiving, from the serving cell and based on transmitting the uplink discovery signal to the ES cell, an indication of transition to an active state by the ES cell.

In Aspect 6, the method of Aspect 5 includes communicating with the ES cell based on transitioning to the active state of the ES cell.

In Aspect 7, the method of Aspect 6 includes wherein communicating with the ES cell includes initiating a RACH procedure with the ES cell.

In Aspect 8, the method of any of Aspects 1 to 7 includes wherein transmitting the discovery signal identifier is over a PUCCH or a PUSCH.

Aspect 9 is a method for wireless communications at an ES cell including transmitting, in an ES state, a downlink discovery signal including a discovery signal identifier of the ES cell, receiving, from a serving cell, a resource grant scheduling resources for receiving an uplink discovery signal from a UE, and monitoring the resources for the uplink discovery signal from the UE.

In Aspect 10, the method of Aspect 9 includes receiving, from the UE, the uplink discovery signal over the monitored resources.

In Aspect 11, the method of any of Aspects 9 or 10 includes wherein the downlink discovery signal is a PSS.

In Aspect 12, the method of any of Aspects 9 to 11 includes transitioning from the ES state to an active state based on receiving the uplink discovery signal.

In Aspect 13, the method of Aspect 12 includes transmitting, to the serving cell, an indication of transitioning to the active state.

In Aspect 14, the method of any of Aspects 12 or 13 includes communicating with the UE based on transitioning to the active state.

In Aspect 15, the method of Aspect 14 includes wherein communicating with the UE includes performing a RACH procedure with the UE.

Aspect 16 is a method for wireless communications at a serving cell including receiving, from a UE, a discovery signal identifier for an ES cell discovered by the UE, and transmitting, to the UE, a resource grant scheduling resources for transmitting an uplink discovery signal to the ES cell.

In Aspect 17, the method of Aspect 16 includes transmitting, to the ES cell, a receiving resource grant scheduling resources for receiving the uplink discovery signal from the UE.

In Aspect 18, the method of any of Aspects 16 or 17 includes receiving, from the ES cell, an indication of transitioning to an active state.

In Aspect 19, the method of any of Aspects 16 to 18 includes transmitting, to the UE, an indication of transition to an active state by the ES cell.

Aspect 20 is an apparatus for wireless communication including one or more memories configured to store instructions, and one or more processors communicatively coupled with the one or more memories, where the one or more processors are configured to execute the instructions to cause the apparatus to perform any of the methods of Aspects 1 to 19.

Aspect 21 is an apparatus for wireless communication including means for performing any of the methods of Aspects 1 to 19.

Aspect 22 is a computer-readable medium including code executable by one or more processors for wireless communications, the code including code for performing any of the methods of Aspects 1 to 19.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
transmit, to a serving cell, a discovery signal identifier associated with an energy saving (ES) cell discovered by the apparatus;
receive, from the serving cell, a resource grant scheduling resources for transmitting an uplink discovery signal to the ES cell; and
transmit, using the resources, the uplink discovery signal to the ES cell.

2. The apparatus of claim 1, wherein the one or more processors are, individually or in combination, configured to execute the instructions to cause the apparatus to receive, from the ES cell, a downlink discovery signal indicating the discovery signal identifier, and transmit the discovery signal identifier to the serving cell based on receiving the downlink discovery signal.

3. The apparatus of claim 2, wherein the downlink discovery signal includes a reference signal indicating presence of the ES cell.

4. The apparatus of claim 2, wherein the downlink discovery signal is a primary synchronization signal (PSS).

5. The apparatus of claim 1, wherein the one or more processors are, individually or in combination, configured to execute the instructions to cause the apparatus to receive, from the serving cell and based on transmitting the uplink discovery signal to the ES cell, an indication of transition to an active state by the ES cell.

6. The apparatus of claim 5, wherein the one or more processors are, individually or in combination, configured to execute the instructions to cause the apparatus to communicate with the ES cell based on transitioning to the active state of the ES cell.

7. The apparatus of claim 6, wherein the one or more processors are, individually or in combination, configured to execute the instructions to cause the apparatus to communicate with the ES cell including initiating a random access channel (RACH) procedure with the ES cell.

8. The apparatus of claim 1, wherein the one or more processors are, individually or in combination, configured to execute the instructions to cause the apparatus to transmit the discovery signal identifier over a physical uplink control channel (PUCCH) or a physical uplink shared channel (PUSCH).

9. An apparatus for wireless communication, comprising:
a transceiver;
one or more memories configured to, individually or in combination, store instructions; and
one or more processors communicatively coupled with the one or more memories, wherein the one or more processors are configured to execute the instructions to cause the apparatus to:
transmit, in an energy saving (ES) state, a downlink discovery signal including a discovery signal identifier of the apparatus;
receiving, from a serving cell, a resource grant scheduling resources for receiving an uplink discovery signal from a user equipment (UE); and
monitoring the resources for the uplink discovery signal from the UE.

10. The apparatus of claim 9, wherein the one or more processors are, individually or in combination, configured to execute the instructions to cause the apparatus to receive, from the UE, the uplink discovery signal over the monitored resources.

11. The apparatus of claim 9, wherein the downlink discovery signal is a primary synchronization signal (PSS).

12. The apparatus of claim 9, wherein the one or more processors are, individually or in combination, configured to execute the instructions to cause the apparatus to transition from the ES state to an active state based on receiving the uplink discovery signal.

13. The apparatus of claim 12, wherein the one or more processors are, individually or in combination, configured to execute the instructions to cause the apparatus to transmit, to the serving cell, an indication of transitioning to the active state.

14. The apparatus of claim 12, wherein the one or more processors are, individually or in combination, configured to execute the instructions to cause the apparatus to communicate with the UE based on transitioning to the active state.

15. The apparatus of claim 14, wherein the one or more processors are, individually or in combination, configured to execute the instructions to cause the apparatus to communicate with the UE including performing a random access channel (RACH) procedure with the UE.

16. A method for wireless communication at a user equipment (UE), comprising:
transmitting, to a serving cell, a discovery signal identifier associated with an energy saving (ES) cell discovered by the UE;
receiving, from the serving cell, a resource grant scheduling resources for transmitting an uplink discovery signal to the ES cell; and
transmitting, using the resources, the uplink discovery signal to the ES cell.

17. The method of claim 16, further comprising receiving, from the ES cell, a downlink discovery signal indicating the discovery signal identifier, wherein transmitting the discovery signal identifier to the serving cell is based on receiving the downlink discovery signal.

18. The method of claim 17, wherein the downlink discovery signal includes a reference signal indicating presence of the ES cell.

19. The method of claim 17, wherein the downlink discovery signal is a primary synchronization signal (PSS).

20. The method of claim 16, further comprising receiving, from the serving cell and based on transmitting the uplink discovery signal to the ES cell, an indication of transition to an active state by the ES cell.

21. The method of claim 20, further comprising communicating with the ES cell based on transitioning to the active state of the ES cell.

22. The method of claim 21, wherein communicating with the ES cell includes initiating a random access channel (RACH) procedure with the ES cell.

23. The method of claim 16, wherein transmitting the discovery signal identifier is over a physical uplink control channel (PUCCH) or a physical uplink shared channel (PUSCH).

24. A method for wireless communications at an energy saving (ES) cell, comprising:
transmitting, in an ES state, a downlink discovery signal including a discovery signal identifier of the ES cell;
receiving, from a serving cell, a resource grant scheduling resources for receiving an uplink discovery signal from a user equipment (UE); and
monitoring the resources for the uplink discovery signal from the UE.

25. The method of claim 24, further comprising receiving, from the UE, the uplink discovery signal over the monitored resources.

26. The method of claim 24, wherein the downlink discovery signal is a primary synchronization signal (PSS).

27. The method of claim 24, further comprising transitioning from the ES state to an active state based on receiving the uplink discovery signal.

28. The method of claim 27, further comprising transmitting, to the serving cell, an indication of transitioning to the active state.

29. The method of claim 27, further comprising communicating with the UE based on transitioning to the active state.

30. The method of claim 29, wherein communicating with the UE includes performing a random access channel (RACH) procedure with the UE.
